(19) United States
(12) Patent Application Publication
(10) Pub. No.: US 2007/0280477 A1
(43) Pub. Date: Dec. 6, 2007

(54) Method and system for providing conditional access authorizations to a mobile receiving device

(75) Inventors: John Norin, Redondo Beach, CA (US); Scott Casavant, Germantown, MD (US); Jorge Guzman, Gaithersburg, MD (US); Sean S. Lee, Rockville, MD (US); Brian Jupin, Germantown, MD (US)

Correspondence Address: THE DIRECTV GROUP, INC.;PATENT DOCKET ADMINISTRATION, CA / LA1 / A109, P O BOX 956, EL SEGUNDO, CA, 90245-0956, US

(73) Assignee: The DirecTV Group, Inc.

(21) Appl. No.: 11/593,712

(22) Filed: Nov. 7, 2006

Related U.S. Application Data
(60) Provisional application No. 60/810,978, filed on Jun. 5, 2006.
(60) Provisional application No. 60/811,045, filed on Jun. 5, 2006.
(60) Provisional application No. 60/810,968, filed on Jun. 5, 2006.
(60) Provisional application No. 60/810,979, filed on Jun. 5, 2006.

(51) Int. Cl. H04N 7/167

(52) U.S. Cl. 380/240

(57) ABSTRACT

A system and method for providing conditional access authorizations in a satellite-receiving system includes generating a conditional access signal at a head-end 20, receiving the conditional access signal at a fixed satellite receiver 54. The conditional access signal is communicated from the fixed satellite receiver 54 to a mobile satellite receiver 28. Conditional access is stored in the mobile satellite receiver 28 and enables the use of the signals by the mobile satellite receiver in response to the conditional access signal.

### RELATED APPLICATIONS

This application claims the benefit of four U.S. provisional applications entitled “DIRECTV2GO-ENTIRE SYSTEM,” filed on Jun. 5, 2006, Ser. No. 60/810,978; “DIRECTV2GO-ENCRYPTION, LICENSE MANAGEMENT,” filed on Jun. 5, 2006, Ser. No. 60/811,045; DIRECTV2GO-SEED MANAGEMENT, REGISTRATION,” filed on Jun. 5, 2006, Ser. No. 60/810,968; and “DIRECTV2GO-SEPARATION OF DIRECTV CONTENT ON PORTABLE DEVICE,” filed on Jun. 5, 2006, Ser. No. 60/810,979. The present application is also related to U.S. patent application entitled “METHOD AND SYSTEM FOR PROVIDING CALL-BACKS FROM A MOBILE RECEIVING DEVICE” (Docket No. PD-206032) filed on the same day herewith. The disclosures of the above applications are incorporated herein by reference.

### TECHNICAL FIELD

The present disclosure relates generally to a mobile satellite receiving devices, and, more specifically, to a method and system to provide conditional access to a mobile receiving device.

### BACKGROUND

Satellite television has become increasingly popular due to its wide variety of programming. Entertainment in automobiles such as DVD players has also become increasingly popular. It would be desirable to provide a satellite television system for a vehicle so that the wide variety of programming may be enjoyed by the rear passengers.

Typical satellite systems include a receiving device that is used to receive satellite signals from the satellites and convert them to a usable format for playback on a television or monitor. Conditional access in conventional home-based systems is granted through a telephone wire coupled to the satellite receiving device. A conditional access signal grants the user rights to view the satellite signal content. These signals expire after a time period and must again be received to continue viewing or using the satellite signals. Mobile receiving device are not connected to a hard-wired line due to mobility.

It would therefore be desirable to provide a system and method for granting conditional access to a mobile receiving device.

### SUMMARY

One feature of the disclosure sets forth a method that includes generating a conditional access signal, receiving the conditional access signal at a fixed satellite receiver, communicating the conditional access signal to a mobile playback device from the fixed satellite receiver, storing the conditional access signal on a mobile satellite receiver and enabling use of satellite signals by the mobile in response to the conditional access signal.

Another feature of the disclosure is a system that includes a fixed satellite receiver receiving a conditional access signal. The fixed receiver communicates a conditional access signal, and a mobile satellite receiver receiving the conditional access signal and enabling use of a satellite signal in response to the conditional access signal.

One advantage of the system is that various technologies or multiple technologies may be used to provide the conditional access.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a system level view of a satellite broadcasting system according to the present invention.

FIG. 2 is a block diagrammatic view of a home-based receiving system according to the present invention.

FIG. 3 is a block diagrammatic view of a mobile receiving system according to the present invention.

FIG. 4 is a flow chart illustrating one method for operating the present invention.

FIG. 5 is a flow chart illustrating a second method for operating the present invention.

FIG. 6 is a flow chart illustrating a third method for operating the present invention.

### DETAILED DESCRIPTION

In the following figures the same reference numerals will be used for the same components. The following figures are described with respect to a mobile satellite television system. However, those skilled in the art will recognize the teachings of the present invention may be applied to various types of mobile reception including land-based type systems. The present invention may be implemented using various types of electronic devices. Thus, the present invention not only relates to mobile satellite television receiving devices, but to non-mobile applications and other electronic devices

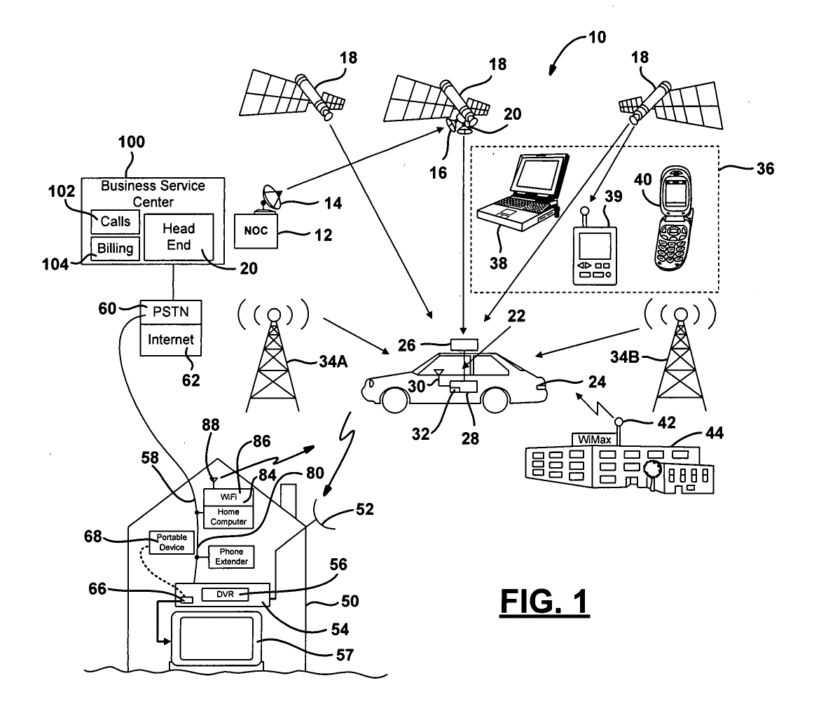

Referring now to FIG. 1, a satellite television broadcasting system 10 is illustrated. The satellite television broadcasting system 10 includes a network operations center 12 that generates wireless signals through a transmitting antenna 14 which are received by a receiving antenna 16 of a satellite 18. The wireless signals, for example, may be digital. A transmitting antenna 20 generates signals directed to various receiving systems including stationary systems such as those in the home as well as mobile receiving systems 22. The wireless signals may have various types of information associated with them including location information. The wireless signals may also have various video and audio information associated therewith. As illustrated, the mobile receiving system 22 is disposed within an automotive vehicle 24. A mobile receiving antenna 26 receives the wireless signals from the satellite 18 and processes the signals in a mobile receiving unit 28. The mobile receiving unit 28 may be similar a set top box or an integrated receiver decoder and will be further described below. The mobile receiving unit 28 may also include a separate antenna 30 and a receiver 32 for receiving various content from a home-base system as will be described below.

The system may also be used for displaying various wireless information on a personal mobile device 36 such as a dedicated satellite television device or a laptop computer 38, a personal digital assistant 39, and a cellular telephone 40. It should be noted that these devices and the automotive-based devices may also receive wireless signals having various types of information associated therewith from the cellular towers 34A and 34B. Other types of information may be broadcast from various other types of broadcasting areas such as an antenna 42 on a building 44. The building 44 may be various types of buildings such as a store and the wireless information transmitted from the antenna 42 may be advertising information. WiMax is one example of a suitable protocol. All of the wireless signals preferably include location information transmitted therewith. As will be described below, the information may be coded digitally into the signals. Thus, by reviewing the location information, signals appropriate for the location of the mobile devices may be displayed on the various devices.

A building or home 50 is illustrated having a fixed antenna 52. The fixed antenna 52 is coupled to a receiving unit 54. The receiving device 54 may also be referred to as an integrated receiver decoder. The receiving device 54 receives the satellite signals through the antenna 52 and converts them into audio and video files to be played on television monitor 56. The receiving unit may include a digital video recorder 56. Often times, the receiving device 54 may be coupled to a telephone line 58 which in turn is coupled to the public service telephone network 60 and which may also be coupled to the Internet 62. The telephone line may be used to grant conditional access and provide a means to place call-backs from the receiving device. The receiving device 54 may also include a transmitter 66 that is used to communicate with a portable device 68. As will be described below, call-in signals including conditional access signals from the DVR 56 may be transferred through the transmitter 66 to the portable device 68 so that it may be used by the mobile receiving unit 28. Call-backs may be performed in a reverse manner. The transmitter 66 may be an RF infrared, Bluetooth, WiFi, WiMax or WiMax mobile transmitter. It should be noted that the transmitter 66 may be a wireless or wired connection to the portable device 68.

As is mentioned above, the receiving device 54 may be coupled to a phone line 58. This allows another method for file transfers, call-backs and call-in signals such as a conditional access signals from the receiving device 54 to the receiving device 28 and vice versa. A signal may be exchanged using a wireless phone extender 80. The wireless phone extender 80 generates over-the-air signals that may be received through the antenna 30 of the receiving device 28.

A home computer 84 may also be coupled to the phone wire 58. In this example, the phone wire may also be a cable wire. By coupling the home computer 84 to the receiving device 54, various actions may be controlled such as a signal or file transfer from the receiving device 54 to the mobile receiving device 28 through a particular protocol or network such as a WiFi network 86. The WiFi network 86 may generate signals through antenna 88. Various frequencies may be used in the WiFi network.

A central location such as a business service center 100 may be coupled to the public service telephone network (PSTN) 60. The business service center 100 is typically used in a DirecTV-type system for billing, Pay-Per-View and interactive programming. The business center 100 may receive calls 102 and provide billing services 104. The business service center 100 may also act as a head end 106 coupled to network operation center 12. The business service center 100 may allow household keys to be stored on the receiving device 54. A second household key may be provided to the receiving device 28. When content is transferred from the home-based receiving device 54 to the mobile receiving device 28, the keys must match to allow playback. Thus, only mobile receivers 28 belonging to the customers of the home-based receiving device 54 are allowed playback of the particular audio and video files. The business center 100 or head end 20 may receive call-back signals allow authorizations to view pay per view, for interactive services, for gaming and the like. The business center 100 or head end 20 may also provide call in to grant authorizations and provide the system with other information signals.

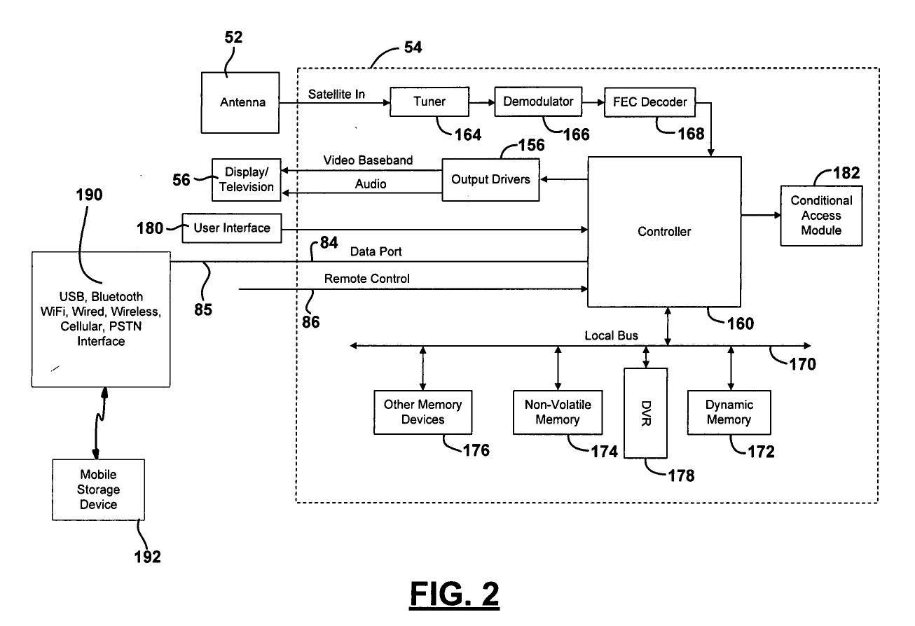

Referring now to FIG. 2, a receiving device 54 is illustrated in further detail. Although a particular configuration of the receiving device 54 is illustrated, it is merely representative of various electronic devices with internal controllers that may be used as a receiving device. Antenna 252 may be various types of antennas having various numbers of low noise blocks. The antenna 252 may be a single antenna used for satellite television reception. The antenna 26 may also be an electronic antenna separate or integral with the device.

A display 57 such as a television may be coupled to or in communication with the receiving device 54. The display 57 may include output drivers 156 used for generating the desired audio and video outputs suitable for the particular display 57.

A controller 160 may be a general processor such as a microprocessor. The controller 160 may be used to coordinate and control the various functions of the receiving unit 54. These functions may include a tuner 164, a demodulator 166, a forward error correction decoder 168 and any buffers and other functions. The tuner 164 receives the signal or data from the individual channel. The demodulator 166 demodulates the signal or data to form a demodulated signal or data. The decoder 168 decodes the demodulated signal to form decoded data or a decoded signal. The controller 160 may be similar to that found in current DirecTV set top boxes which employ a chip-based multifunctional controller.

The controller 160 may include or be coupled to a local bus 170. The local bus 170 may be used to couple a dynamic memory 172 such as RAM which changes often and whose contents may be lost upon the interruption of power or boot up. The bus 170 may also be coupled to a non-volatile memory 174. The non-volatile memory may be an in-circuit programmable type memory. One example of a non-volatile memory is an EEPROM. One specific type of EEPROM is flash memory. Flash memory is suitable since it is sectored into blocks of data segments that may be individually erased and rewritten.

Other memory devices 176 may also be coupled to local bus 170. The other memory devices may include other types of dynamic memory, non-volatile memory, or may include such devices such as a digital video recorder (DVR) 178. The display 56 may be changed under the control of controller 260 in response to the data in the dynamic memory 172 or non-volatile memory 174. The DVR 178 may store various audio and video files to be transferred.

The controller 160 may also be coupled to a user interface 180. User interface 180 may be various types of user interfaces such as a keyboard, push buttons, a touch screen, a voice activated interface, or the like. User interface 180 may be used to select a channel, select various information, change the volume, change the display appearance, or other functions. The user interface 180 is illustrated as part of the mobile receiving unit. However, should the unit be incorporated into a vehicle, the user interface 180 may be located external to the mobile receiving unit such as dial buttons, voice activated system, or the like incorporated into the vehicle and interface with the mobile receiving unit.

A conditional access module card 182 (CAM) may also be incorporated into the mobile receiving unit. Access cards such as a conditional access module (CAM) cards are typically found in DirecTV units. The access card 82 may provide conditional access to various channels and wireless signals generated by the system. Not having an access card or not having an up-to-date access card 182 may prevent the user from receiving or displaying various wireless content from the system.

FIG. 2 also shows an interface 190. The interface 190 may be external to the receiver 54 or internal to the receiver 54. The interface 190 may include the functions of the transmitter 66 illustrated in FIG. 1. The interface 190 is used to communicate files stored within the memory of receiver 54 to the mobile receiver 28. This may be done directly through a WiFi, WiMax, WiMax mobile, wireless, cellular or other communication directly to the mobile receiver 28.

The interface 190 may also be coupled to a mobile storage device 192. The mobile storage device 192 receives files for transfer to the mobile receiving unit 28. The mobile storage device 192 may be a simple memory that is coupled to the interface 192 through a USB-type port. Of course, other types of ports or protocols may be used to couple a memory thereto. Other types of devices include a portable hard disk drive, a portable chip base system, or the like. The files loaded on to the mobile storage device may include the household key for security.

The interface 90 may also include the function of a wireless phone extender or a cellular phone transmitter.

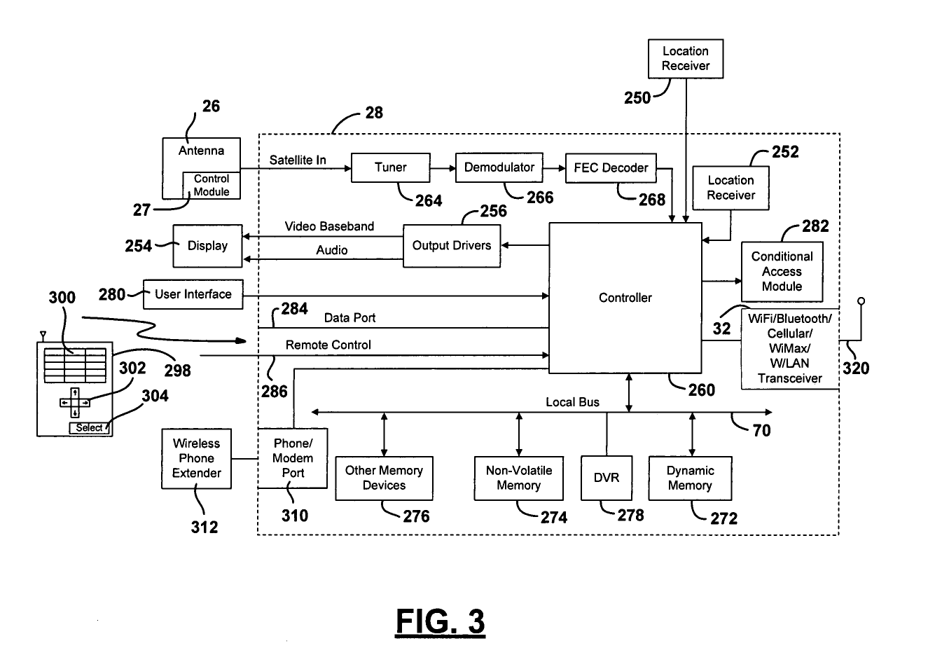

Referring now to FIG. 3, the receiving unit 28 is illustrated in further detail. Although the receiving unit 28 is illustrated, or is merely representative of various electronic devices with internal controllers. Antenna 26 may be various types of antennas including a rotating antenna which is used to track the relative movement of the satellite or other transponding device with respect to the vehicle. The antenna 26 may be a single antenna used for satellite television reception, or a number of antennas such as one for receiving television signals and one coupled to a location receiver 250 such as GPS receiver. The antenna 26 may also be an electronic antenna such as a phased array or a panel antenna. The antenna 26 may include an internal controller 27 that controls the operation of the antenna 26.

The mobile receiver unit 28 may be coupled to antenna 26 with a two-way communication channel such as a wire or a wireless system. The mobile receiving unit 28 may also include a location receiver 252 integrated therein. The location receiver 252 may be a GPS receiver. In a preferred embodiment, only one location receiver 250, 252 may be provided in the system. However, the location receiver 250, 252 may be part of the vehicle 24 or may be part of the mobile receiving system 22, 36. The controller 260 may be coupled directly to location receiver 252 and/or location receiver 250. The mobile receiving unit 28 includes a display 254. The display 254 may be incorporated into the device 28 or within the vehicle 24. The display 254 may include output drivers 256 used for generating the desired audio and video outputs suitable for the particular display 254.

A controller 260 may be a general processor such as a microprocessor. The controller 260 may be used to coordinate and control the various functions of the receiving unit 28. These functions may include a tuner 264, a demodulator 266, a forward error correction decoder 268 and any buffers and other functions. The tuner 264 receives the signal or data from the individual channel. The demodulator 266 demodulates the signal or data to form a demodulated signal or data. The decoder 268 decodes the demodulated signal to form decoded data or a decoded signal. The controller 260 may be similar to that found in current DirecTV set top boxes that employ a chip-based multifunctional controller.

The controller 260 may include or be coupled to a local bus 270. The local bus 270 may be used to couple a dynamic memory 272 such as RAM that changes often and whose contents may be lost upon the interruption of power or boot up. The bus 270 may also be coupled to a non-volatile memory 274. The non-volatile memory may be an in-circuit programmable type memory. One example of a non-volatile memory is an EEPROM. One specific type of EEPROM is flash memory. Flash memory is suitable since it is sectored into blocks of data segments that may be individually erased and rewritten.

Other memory devices 276 may also be coupled to local bus 270. The other memory devices may include other types of dynamic memory, non-volatile memory, or may include such devices such as a digital video recorder 278. The display 254 may be changed under the control of controller 260 in response to the data in the dynamic memory 272, non-volatile memory 274 or memory 278.

The controller 260 may also be coupled to a user interface 280. User interface 280 may be various types of user interfaces such as a keyboard, push buttons, a touch screen, a voice activated interface, or the like. User interface 280 may be used to select a channel, select various information, change the volume, change the display appearance, or other functions. The user interface 280 is illustrated as part of the mobile receiving unit. However, should the unit be incorporated into a vehicle, the user interface 280 may be located external to the mobile receiving unit such as dial buttons, voice activated system, or the like incorporated into the vehicle and interface with the mobile receiving unit.

One example of a user interface 280 is a remote control device 298 having a key pad 300, an arrow key pad 302, and a select button 304. Inputs to the receiver 28 may be provided by the remote control device 298 or through another type of user interface 280.

A conditional access module card 282 (CAM) may also be incorporated into the mobile receiving unit. Access cards such as a conditional access module (CAM) cards are typically found in DirecTV units. The access card 282 may provide conditional access to various channels and wireless signals generated by the system. Not having an access card or not having an up-to-date access card may prevent the user from receiving or displaying various wireless content from the system. The conditional access card may require a conditional access signal periodically to allow the satellite signals to be used or played back.

The controller 260 may be coupled to a data port 284 that is used to send or receive data and a remote control input 286 for receiving data from a wired or wireless remote control device.

Controller 260 may be coupled to a wireless or wired modem port 310. The wireless or wired phone/modem port may be coupled to a wireless phone extender 312. The wireless phone extender 312 is used to communicate with the interface 190 in the home-based receiver unit 54.

Controller 260 may also be coupled to an interface 32 that may include an antenna 320. The interface 32 may include a WiFi, WiMax, Bluetooth, cellular, wireless LAN, or the like. Signals and files received through the interface 232 may be stored on the DVR 278 for eventual playback and display on the display 254.

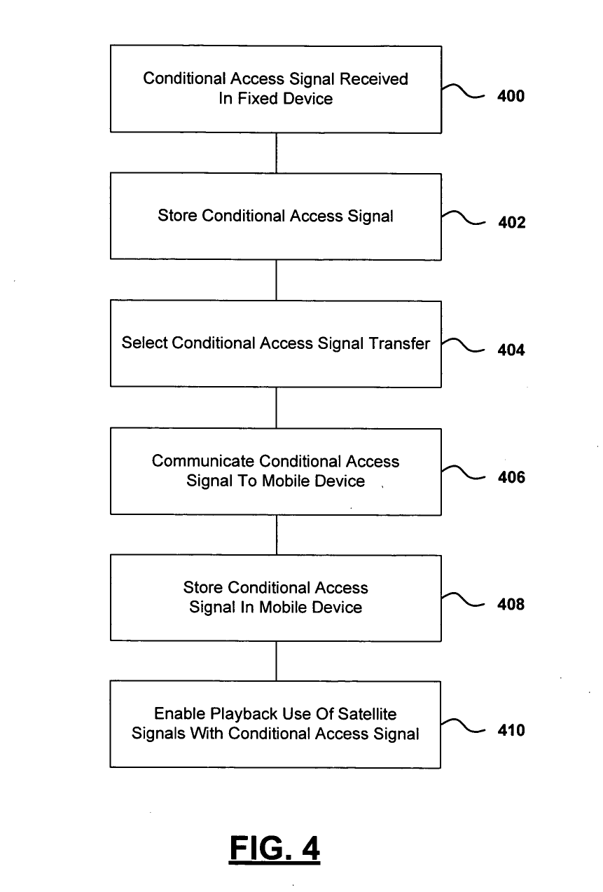

Referring now to FIG. 4, a method of granting conditional access is set forth. In step 400, a conditional access signals having data therein is received in a home or fixed receiving device 54.

In step 402, conditional access signals from are stored on a first receiving device such as a home-based receiving device.

A conditional access signal may be transferred by selecting from a menu or the like in step 404. The menu may, for example, be an on-screen-type menu listing the conditional access signal to transfer. This could also be an automated process that is periodically performed. Upon selection by a user interface, the conditional access signal may be communicated to the mobile receiving device in step 406. The conditional access signal may be communicated in a various number of manners including using an intermediate mobile storage device 192 illustrated in FIG. 2. Various types of devices may be used for the transfer including wired and non-wired transfers through an interface. For a mobile storage device 192, a USB connection may be used. Wireless transfer may include a Bluetooth, WiFi, WiMax, WiMax mobile, wired, wireless, cellular phone or wireless phone. Of course, the wireless methods for transferring may include wirelessly transferring files to the mobile storage device 192.

Communicating the conditional access signal in step 406 may also include storing the signal in a memory in the mobile receiving device.

In step 408, the conditional access signal is stored in the mobile receiving/playback device. In step 410 a satellite signal is received and played or otherwise used in the mobile receiving device with the proper conditional access signal. Playback may include using a display such as a television or an audio system in a vehicle. Step 410 may also include comparing authorizations or a household key to the stored household key. Thus, playback or other use of the satellite signals may be disabled if the household key or the conditional access signals do not match the household key.

The above method may also be used for any call-in signal not just for conditional access signals.

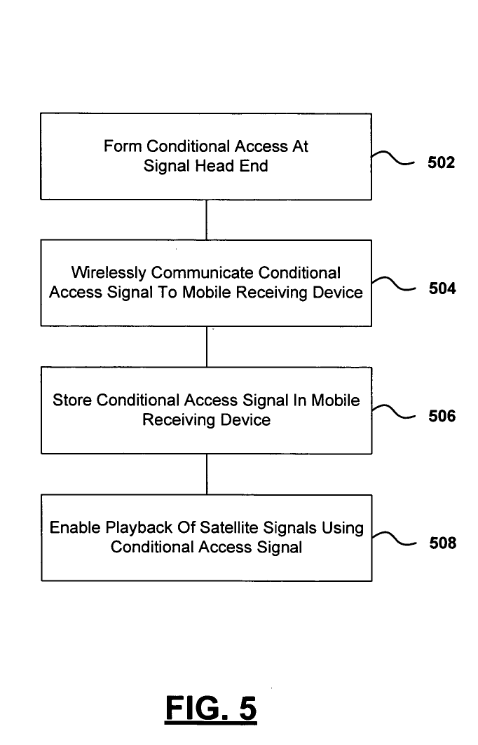

Referring now to FIG. 5, the conditional access signal may be communicated directly from the head end using the various wireless technology described above. In step 502, the conditional access signal is formed at the head end. In step 504, the conditional access signal is wirelessly communicated to the mobile receiving device. In step 506, the conditional access signal is stored in the mobile receiving device. In step 508, the playback of satellite signals is enabled using the conditional access signal.

As mentioned above, the method set forth in FIG. 5 may also be used for various other types of call-in signals. The wireless communication may take place using a wireless network, a WiFi network, a wireless phone extender, cellular phone network, or the like.

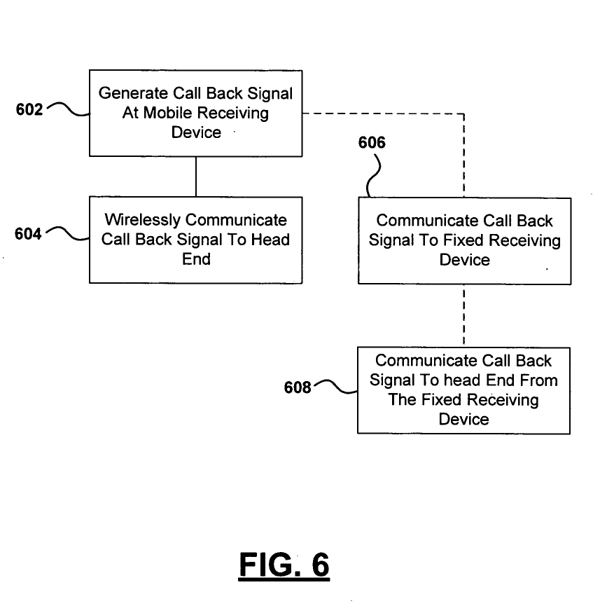

Referring now to FIG. 6, a method of generating call-backs is illustrated. Call-back signals, in this case, originate from the mobile receiving device in response to various actions at the mobile receiving device. For example, a Pay-Per-View request, an interactive television selection or a gaming signal from a video game are all examples of a call-back signal. In step 602, the call-back signal is generated at the mobile device. In step 604, the call-back signal is wirelessly communicated to the head end signal. Various methods are described above for wireless communication including WiFi, WiMax, WiMax mobile, Bluetooth, cellular phones, wireless phone extenders, and the like.

Referring back to step 602, after generating a call-back signal at the mobile receiving device, the signal may be communicated to a fixed receiver device in step 606. The fixed receiver device may be a home-based receiving device. In step 608, the call-back signal is communicated to the head end from the fixed receiver device. Step 606 and 608 may be performed wirelessly, wired, using another device or a combination of the two. For example, the signal in step 606 may be wirelessly communicated to the fixed receiver device and the call-back signal may be communicated using phone lines back to the head-end. Likewise, the call-back signal may also be coupled to a portable memory device which is then coupled to the fixed receiver device and transferred to the fixed receiver device and, ultimately, to the head-end.

While particular embodiments of the invention have been shown and described, numerous variations and alternate embodiments will occur to those skilled in the art. Accordingly, it is intended that the invention be limited only in terms of the appended claims.

What is claimed is:

1. A method comprising:
generating a conditional access signal;
receiving the conditional access signal at a fixed satellite receiver;
communicating the conditional access signal to a mobile playback device from the fixed satellite receiver;
storing the conditional access signal on a mobile satellite receiver; and
enabling use of satellite signals by the mobile satellite receiver in response to the conditional access signal.

2. A method as in claim 1 wherein generating comprises generating the conditional access signal through a satellite.

3. A method as in claim 1 wherein communicating comprises wirelessly communicating conditional access signal.

4. A method as in claim 3 wherein wirelessly communicating the conditional access signal comprises communicating the conditional access signal through a wireless network.

5. A method as in claim 3 wherein wirelessly communicating the conditional access signal comprises communicating the conditional access signal through a WiFi network.

6. A method as in claim 3 wherein wirelessly communicating the conditional access signal comprises communicating the conditional access signal through an extender of a wireless phone network.

7. A method as in claim 3 wherein wirelessly communicating the conditional access signal comprises communicating the conditional access signal through a cellular phone network.

8. A method as in claim 3 wherein communicating comprises storing the conditional access signal on a memory device and further comprising coupling the memory device to a mobile playback device.

9. A method as in claim 1 wherein the mobile satellite receiver comprises a mobile integrated receiver decoder.

10. A method as in claim 1 wherein generating the call-back signal comprises generating the conditional access signal at a head end.

11. A method comprising:
generating a call-in signal;
wirelessly communicating the call-in signal to a mobile satellite signal receiving device; and
operating a mobile satellite signal receiving device in response to the call-in signal.

12. A method as in claim 11 wherein wirelessly communicating comprises wirelessly communicating through a wireless network.

13. A method as in claim 11 wherein wirelessly communicating comprises wirelessly communicating through a WiFi network.

14. A method as in claim 11 wherein wirelessly communicating comprises wirelessly communicating through an extender of a wireless phone network.

15. A method as in claim 11 wherein wirelessly communicating wherein wirelessly communicating comprises wirelessly communicating through a cellular phone network.

16. A system comprising:
a fixed satellite receiver receiving a conditional access signal, said fixed receiver communicating a conditional access signal; and
a mobile satellite receiver receiving the conditional access signal and enabling use of a satellite signal in response to the conditional access signal.

17. A system as recited in claim 16 further comprising a wireless network communicating the conditional access signal to the mobile satellite receiver.

18. A system as recited in claim 16 wherein the wireless network comprises a WiFi network

19. A system as recited in claim 16 wherein the wireless network comprises an extender of a wireless phone network.

20. A system as recited in claim 16 wherein the wireless network comprises a cellular phone network.

21. A system as recited in claim 16 further comprising a portable storage device storing the conditional access from the fixed satellite receiver.

22. A system as recited in claim 16 wherein the fixed satellite receiver comprises a home-based satellite television receiver.

23. A system as recited in claim 16 wherein the mobile satellite receiver comprises a vehicle-based satellite television receiver.
